(19) United States
(12) Patent Application Publication
(10) Pub. No.: US 2003/0041633 A1
(43) Pub. Date: Mar. 6, 2003

(54) Reinforcing bracket for locks

(76) Inventors: Eric A. Britz, Wernersville, PA (US); David A. Ebert, Schwenksville, PA (US)

Correspondence Address: Myron B. Kapustij, Masco Corporation, 21001 Van Born Road, Taylor, MI, 48180, US

(21) Appl. No.: 10/231,695

(22) Filed: Aug. 30, 2002

Related U.S. Application Data
(60) Provisional application No. 60/316,576, filed on Aug. 31, 2001.

(51) Int. Cl. E05B 9/08; E05B 15/16

(52) U.S. Cl. 70/134; 70/370; 70/417

(57) ABSTRACT

A reinforcing bracket for a door lock. The reinforcing bracket has a recess in its interior side adapted to receive, at least partially surround, and support the bolt body of the bolt assembly of the lock. The reinforcing bracket also has a central opening extending therethrough to receive the cylinder plug cap of the cylinder assembly of the lock.

### RELATED APPLICATIONS

This application claims priority from U.S. Provisional Application No. 60/316,576 filed on Aug. 31, 2001.

### FIELD OF THE INVENTION

The present invention relates to locks, more particularly deadbolt locks.

### BACKGROUND OF THE INVENTION

This invention is directed to door locks, more particularly deadbolt locks. Presently available door locks such as deadbolt locks are susceptible to forces exerted on them as a result of a break-in type entry or vandal attack applied with a wrench, pipe, or other similar tool applied on the exterior side or outside trim. Such forces cause certain components of the lock to break, and the lock to fail. There is a need for a simple means to reinforce or strengthen the lock. It would be particularly advantageous if this means could be retrofitted to existing locks. The instant invention provides such a means.

### SUMMARY OF THE INVENTION

The instant invention is directed to a door lock, such as a deadbolt lock, operable by a mechanical key and/or a thumbturn with inside and outside trim mounted on a door having an inside face and an outside face.

The purpose of this invention is to increase the strength of the door lock assembly thereby raising the security level of the lock.

A reinforcing bracket is mounted on the cylinder side of the door by insertion into the bore opening of the door. The reinforcing bracket has an internal contour on one side of the bracket which partially encompasses and supports the latch, such as a deadbolt latch body. The opposite side of the support bracket is recessed to completely surround the cylinder body, such as deadbolt cylinder body with a through hole for the knurled cylinder plug cap. The engagement of the cylinder plug cap into the reinforcing bracket increases the load distribution of the assembly. The mounting screws for the product are then inserted through the back plate, reinforcing bracket, latch and fastened into the cylinder body.

The purpose of the bracket is to transfer the exerted load between the mounting fasteners thus allowing the full load to be distributed among internal lock components and the fasteners. The reinforcing bracket creates an integral assembled system forcing the individual components to act as a unit to resist the forces exerted on the lock. The forces are a result of a break-in type entry or vandal attack applied with a pipe wrench or other similar tool on the exterior side or outside trim.

### BRIEF DESCRIPTION OF THE DRAWINGS

FIG. 1 is a perspective view, in section, of a door with the reinforcing bracket and deadbolt mounted in the door;

FIG. 2 is a perspective view, partly in section, of a door with the reinforcing bracket and deadbolt mounted in the door;

FIG. 3 is a perspective view of the reinforcing bracket with the deadbolt latch body mounted in a recess in the reinforcing body;

FIG. 4 is a top perspective view of a reinforcing bracket which fits into a 2-⅛ inch door borehole;

FIG. 5 is a bottom perspective view of the reinforcing bracket of FIG. 4;

FIG. 6 is a top perspective view of a second embodiment of the reinforcing bracket which fits into a 1-⅝ inch door bore hole;

FIG. 7 is a bottom plan view of the second embodiment of the reinforcing bracket illustrated in FIG. 6;

FIG. 8 is a right side elevational view of the reinforcing bracket;

FIG. 9 is a front elevational view in section of the reinforcing bracket;

FIG. 10 is a left side elevational view of the reinforcing bracket;

FIG. 11 is an exploded perspective view of the door, reinforcing bracket and deadbolt; and

FIG. 12 is an exploded perspective view of the reinforcing bracket and deadbolt.

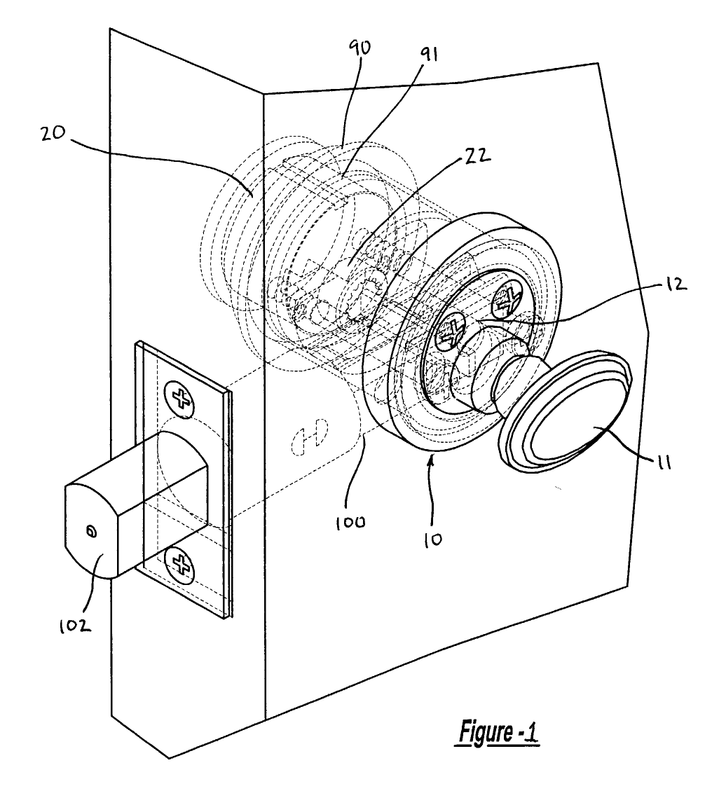

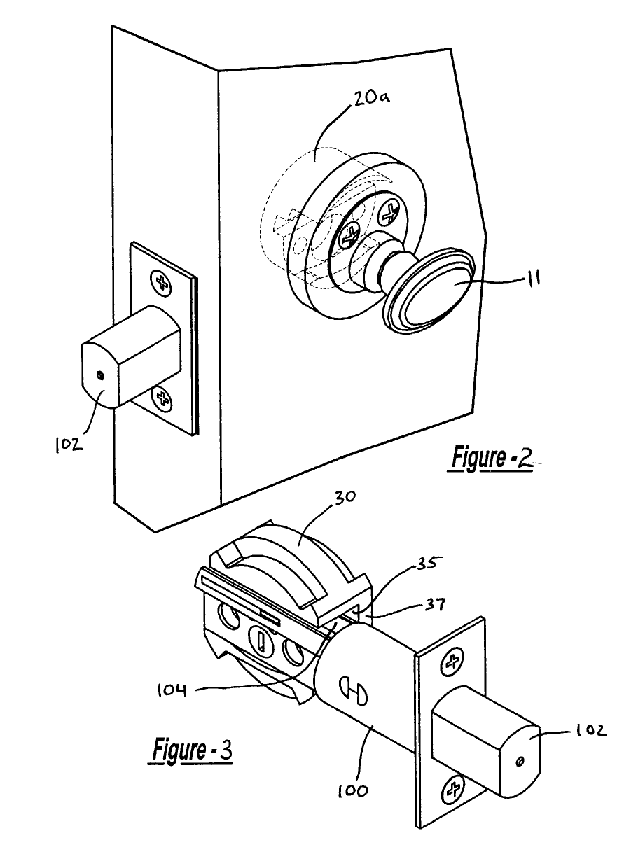

### DESCRIPTION OF THE PREFERRED EMBODIMENT

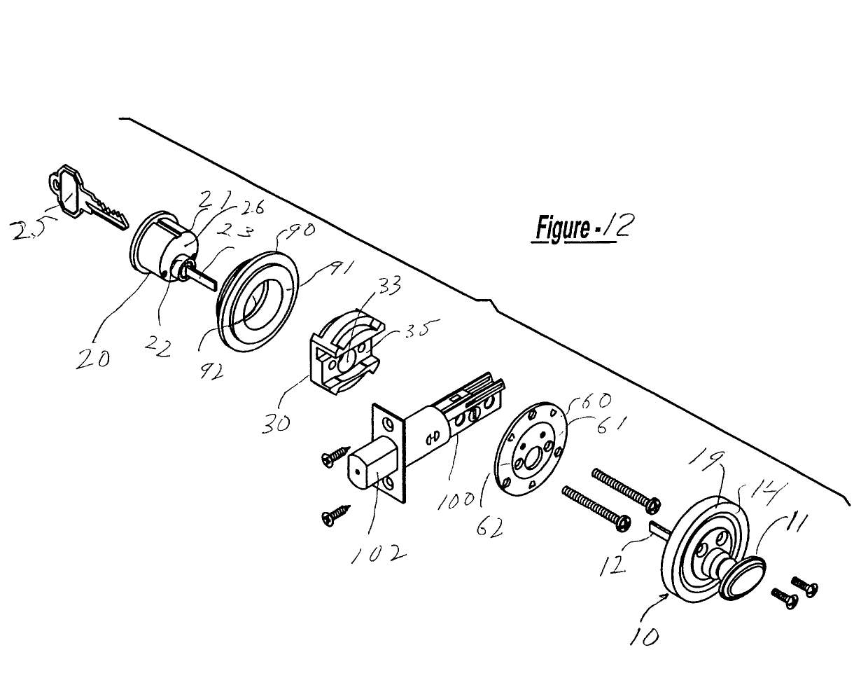

The reinforcing bracket 30 of the instant invention functions to transfer loads to the door and distributes the loads through the rest of the door lock, such as a deadbolt, hardware. The reinforcing bracket of the instant invention can be used with standard, conventional and well known door locks such as a deadbolt. It can be retrofitted to these locks. In one embodiment, as illustrated in the drawings, the lock is a deadbolt lock. The deadbolt can be a single cylinder deadbolt as illustrated in FIGS. 11 and 12 and as described in U.S. Pat. No. 5,351,513, incorporated herein by reference, or a double cylinder deadbolt.

In one embodiment of the present invention, as illustrated in FIGS. 11 and 12, the lock comprises a single cylinder deadbolt. The deadbolt comprises an inside actuating assembly 10 and an outside lock cylinder assembly 20. The outside lock cylinder assembly 20 includes a lock cylinder 21 which may be operated by a key. The lock cylinder 21 is conventional, and well known in the art. It includes a tailpiece 23 and a knurled cylinder plug cap 22.

The inside actuating assembly 10 includes a knob or thumbturn 11 which operates a tailpiece 12. The knob 11 is rotatably mounted in escutcheon 19. The escutcheon 19 has an annular wall 13 and a top wall 14. Escutcheon 12 fits over back plate 60 which, in turn, fits over door bore hole 70. Fastening means, such as screws 15, 16, secure escutcheon 19 to back plate 60. More specifically, annular wall 13 fits over back plate 60.

As best illustrated in FIGS. 11 and 12 screws 80, 81 pass through appropriate openings 61, 62 in plate 60, through appropriate openings in latch body 100, through openings 31, 32 in reinforcing bracket, through cylinder housing collar 90, and into openings 24, 25 in outside lock cylinder 20. Screws 80, 81 thus secure outside lock cylinder to inside actuating assembly 10.

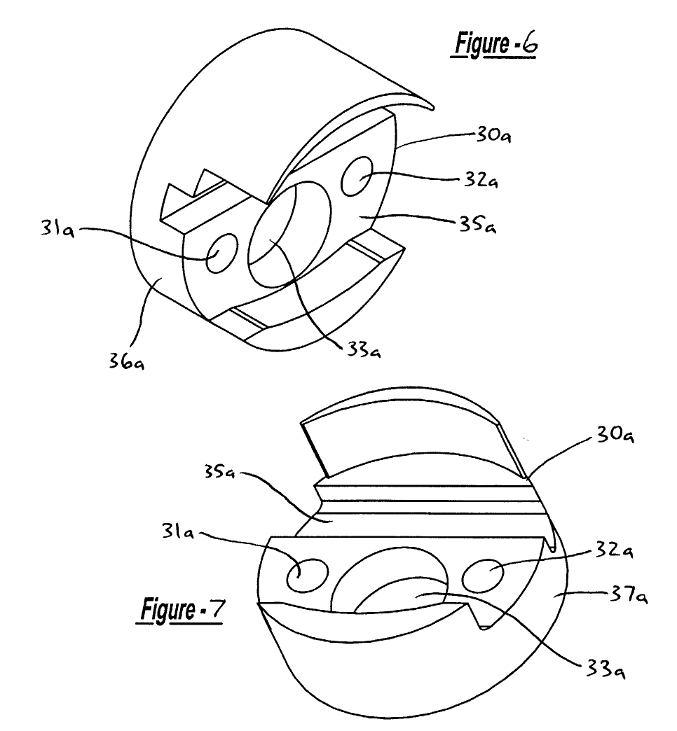

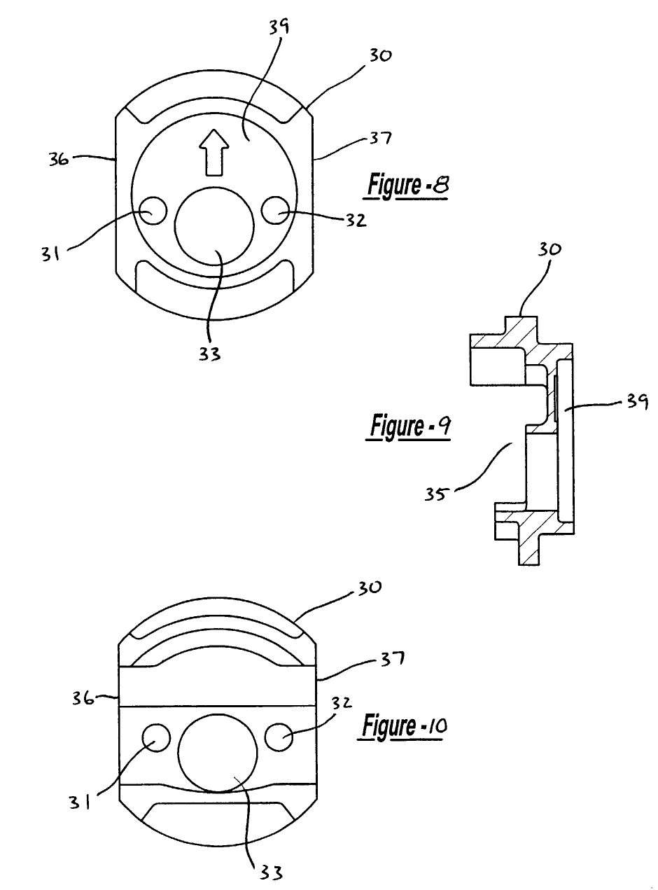

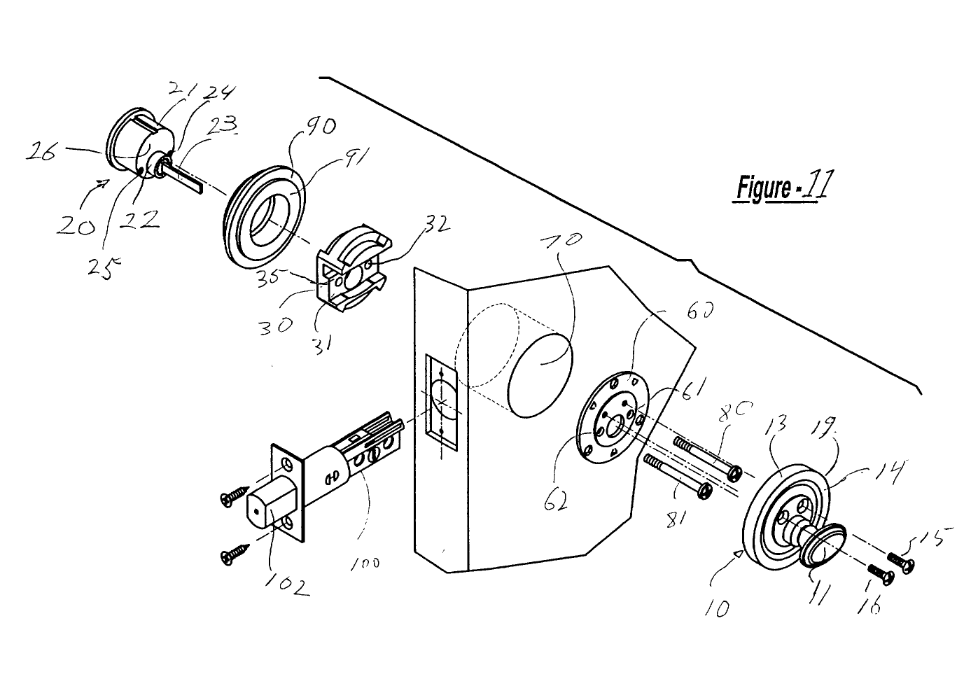

The reinforcing bracket is adapted to fit into a 2-⅛ inch door bore hole or into a 1-⅝ inch door bore hole. The reinforcing bracket illustrated in FIGS. 3-5 and 8-12 is one which fits into a 2-⅛ inch door bore hole. The reinforcing bracket illustrated in FIGS. 6 and 7 fits into a 1-⅝ inch door bore hole.

The reinforcing bracket 30 has two screw holes 31, 32 to allow screws 80, 81 to pass therethrough. The reinforcing bracket 30 also has a central through hole 33 therein. The tailpiece 23 and the knurled cylinder plug cap 22 of cylinder assembly 20 extends through hole 33 while the face 26 of cylinder body 21 is in contact with and abuts recess 39. This arrangement is partially responsible for an increase in the load distribution of the entire lock assembly. The interior or inner side of the reinforcing bracket has a recess 35 sized and shaped to at least partially surround the bolt body 104 of bolt assembly 100 as best illustrated in FIG. 3. As best illustrated in FIG. 9 there is a recess 39 on the side of the support bracket opposite the side which contains recess 35. The recess 39 is generally circular in shape. Cylinder housing collar 90, as best shown in FIGS. 11 and 12, is generally ring shaped with a central opening 92 which receives lock cylinder assembly 20. Collar 90 has a raised annular section 91 which is inserted into door bore hole 70.

The bolt assembly 100 has a bolt head reciprocably movable into and out of said bolt assembly 100 which is engaged by tailpiece 23 or tailpiece 12 in a well known and conventional manner. The bolt assembly 100 is conventional and well known.

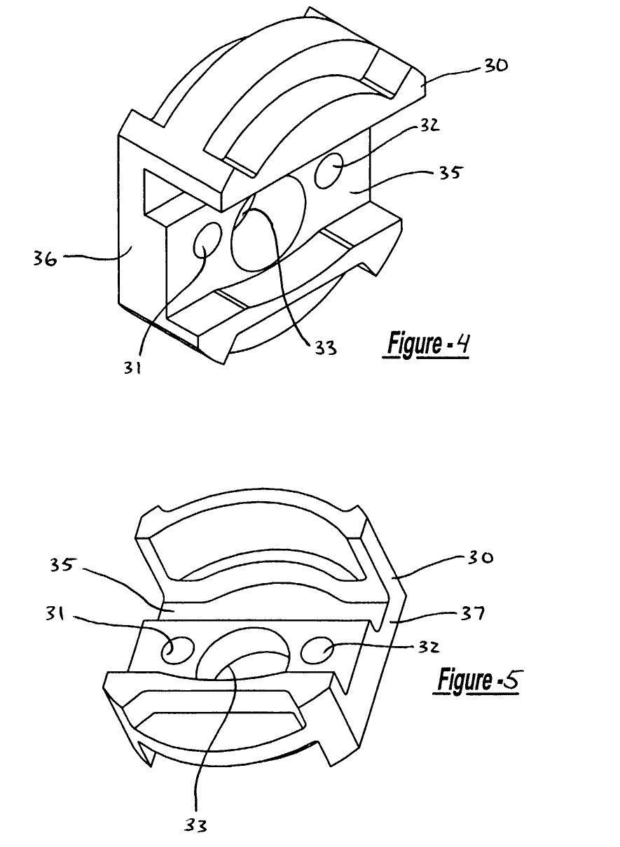

In the embodiments illustrated in FIGS. 4 and 5 the reinforcing bracket has straight sides 36, 37 while in the embodiment illustrated in FIGS. 6 and 7 the reinforcing bracket has curved sides 36a, 37A.

What is claimed is:

1. A reinforcing bracket for a lock comprising an exterior side and an interior side, the interior side having a recess adapted to receive and at least partially surround the bolt body of the bolt assembly of said lock, the exterior side having a recess therein adapted to abuttingly receive the face of the cylinder body of said lock, and a central opening extending through said reinforcing bracket adapted to receive the cylinder plug cap of the cylinder assembly of said lock.

2. The reinforcing bracket of claim 1 wherein said central opening extends through said recess in said interior side of said bracket.

3. The reinforcing bracket of claim 2 wherein said central opening extends through said recess in the exterior side of said bracket.

4. The reinforcing bracket of claim 1 wherein said reinforcing bracket is mounted in the outside or exterior side of the door containing said lock.

5. The reinforcing bracket of claim 1 which has two screw openings, one on each side of said central opening adapted for the passage of lock mounting screws thereto.

6. The reinforcing bracket of claim 1 wherein said reinforcing bracket has a curved top section, a curved bottom section, and two straight side sections.

7. The reinforcing bracket of claim 6 wherein said curved top section and curved bottom section protrude outwardly over said recess in said interior side.

8. The reinforcing bracket of claim 7 wherein said reinforcing bracket is mounted in the bore opening of a door on the lock cylinder side of said door.

9. The reinforcing bracket of claim 8 wherein said top curved section and said bottom curved section conform to the contour of said bore opening.
